(19) United States
(12) Patent Application Publication
(10) Pub. No.: US 2025/0258426 A1
(43) Pub. Date: Aug. 14, 2025

(54) PROJECTION SCREEN

(71) Applicant: LINTEC CORPORATION, Tokyo (JP)

(72) Inventors: Tatsuki KURAMOTO, Tokyo (JP); Kentaro KUSAMA, Tokyo (JP); Baku KATAGIRI, Tokyo (JP); Akihira WATANABE, Tokyo (JP)

(73) Assignee: LINTEC CORPORATION, Tokyo (JP)

(21) Appl. No.: 18/847,031

(22) PCT Filed: Oct. 4, 2022
(86) PCT No.: PCT/JP2022/037111

§ 371 Date: Apr. 11, 2025

(30) Foreign Application Priority Data
Mar. 17, 2022 (JP) 2022-043156

(51) Int. Cl. G03B 21/62; G02B 5/02

(52) U.S. Cl. CPC G03B 21/62; G02B 5/0236

(57) ABSTRACT

Projection screen (1) includes a light diffusion control film (10) having an incident light diffusion angle region. When the projection screen (1) is installed vertically to the ground surface, the incident light diffusion angle region in an up-down direction does not include a front face 0° in the horizontal direction with respect to the ground surface, and the haze value at the above front face 0° is 1% or more and 80% or less. According to the projection screen (1), it is possible to suppress unwanted reflection of images projected from a projector onto those other than the projection screen.

### TECHNICAL FIELD

The present invention relates to a projection screen.

### BACKGROUND ART

In recent years, projectors have been used to display images (including the concept of video) on projection screens. Among projection screens, as an example, a transmissive projection screen is becoming known. The transmissive projection screen displays an image projected from a projector to viewers who are on the opposite side of the projector across the transmissive projection screen.

In such a transmissive projection screen, after the light from the projector is focused on the screen to display an image, the light that passes through the screen may be focused on another location, such as on the ceiling or floor, and reflected to form an unwanted image.

To solve the problems such as those described above, Patent Document 1 proposes a transparent screen having predetermined anisotropy for the light emitted from the transparent screen itself. The transparent screen includes scattering layers that function to project image light on the transparent screen. The scattering layers include a first scattering layer that causes scattering of the image light and a second scattering layer that imparts the anisotropy to the transparent screen. When the transparent screen is installed vertically so as to exhibit the anisotropy in an up-down direction, that is, when the first scattering layer is located on the side of a first surface of the transparent screen and the second scattering layer is located on the side of a second surface opposite to the first surface or the first scattering layer is located on the second surface side and the second scattering layer is located on the first surface side, in the second scattering layer, the scattering of light entering from the upper direction to the first surface side of the second scattering layer is stronger than the light entering from the lateral direction to the first surface side of the second scattering layer.

### PRIOR ART DOCUMENTS

### Patent Documents

[Patent Document 1] JP2019-74730A

### SUMMARY OF THE INVENTION

### Problems to be Solved by the Invention

The projection screen described in Patent Document 1 requires the first scattering layer and the second scattering layer and thus requires a number of steps for production. It is therefore desirable to solve the above-described problems even with a simpler configuration.

The present invention has been made in view of such actual circumstances, and an object of the present invention is to provide a projection screen that can suppress unwanted reflection of images projected from a projector onto those other than the projection screen.

### Means for Solving the Problems

To achieve the above object, the present invention provides a projection screen comprising a light diffusion control film having an incident light diffusion angle region, wherein when the projection screen is installed vertically to a ground surface, the incident light diffusion angle region in an up-down direction does not include a front face 0° in a horizontal direction with respect to the ground surface, and a haze value at the front face 0° is 1% or more and 80% or less (Invention 1).

In the above invention (Invention 1), it is possible to suppress unwanted reflection of images projected from a projector onto those other than the projection screen. It is also possible to increase the luminance of images projected on the projection screen, and the image visibility is excellent when the projector is turned on. Furthermore, when the projector is turned off, background visibility is excellent, particularly from the front.

In the above invention (Invention 1), when the projection screen is installed vertically to the ground surface and light is incident on the projection screen at an angle of 60° in the up-down direction from a horizontal plane, a transmission gain at the front face 0° may be preferably 0.05 or more (Invention 2).

In the above invention or inventions (Inventions 1 and 2), the incident light diffusion angle region of the light diffusion control film may be preferably 0° or more and less than 90° (Invention 3).

In the above invention or inventions (Inventions 1 to 3), the total luminous transmittance at the front face 0° may be preferably 50% or more and 100% or less (Invention 4).

In the above invention or inventions (Inventions 1 to 4), the light diffusion control film may preferably have a louver-shaped internal structure comprising a plurality of regions having a relatively high refractive index in a region having a relatively low refractive index, and the louver-shaped internal structure may be preferably provided so that a longitudinal direction of the louver-shaped internal structure extends horizontally when the projection screen is installed vertically to the ground surface (Invention 5).

In the above invention (Invention 5), the light diffusion control film may preferably contain light-diffusing fine particles (Invention 6).

In the above invention or inventions (Inventions 1 to 6), the projection screen may be preferably a transmissive projection screen (Invention 7).

### Advantageous Effect of the Invention

According to the projection screen of the present invention, it is possible to suppress unwanted reflection of images projected from a projector onto those other than the projection screen.

### BRIEF DESCRIPTION OF DRAWINGS

FIG. 1 is a schematic perspective view illustrating a projection screen according to an embodiment of the present invention.

FIG. 2 is a side view illustrating a method of measuring a 0° gain of a projection screen (a view of the whole including a projector seen from the side).

### EMBODIMENTS FOR CARRYING OUT THE INVENTION

Hereinafter, one or more embodiments of the present invention will be described.

The projection screen according to an embodiment of the present invention includes a light diffusion control film having an incident light diffusion angle region. When the projection screen is installed vertically to the ground surface, the above incident light diffusion angle region in the up-down direction preferably does not include a front face 0° in the horizontal direction with respect to the ground surface. In addition, the haze value at the above front face 0° is preferably 1% or more and 80% or less.

As used in the present specification, the “incident light diffusion angle region” refers to an angle range in which the haze value is 60% or more when the haze value is measured by changing the incident angle of the measurement light to the light diffusion control film.

The projection screen according to the present embodiment having the above configuration has a haze value of 1% or more and 80% or less at the front face 0° in the horizontal direction with respect to the ground surface, and the straight transmitted light can thereby be strongly diffused in the projection screen. Then, the light transmitted through the projection screen will not form an image on another location, such as on the ceiling or floor. Thus, it is possible to suppress unwanted reflection of images on those other than the projection screen, for example, on the ceiling, floor, etc. (this effect may be referred to as an “unwanted image suppression effect,” hereinafter). In addition, when the above haze value is within the above range, the luminance of the image projected from the projector to the projection screen can be increased, thereby providing excellent image visibility when the projector is turned on.

Furthermore, the projection screen according to the present embodiment having the above configuration has excellent background visibility because the incident light diffusion angle region does not include the front face 0°. That is, when the projection screen is viewed from the front with the projector being turned off, the background on the opposite side of the projection screen is readily visible.

The haze value at the front face 0° of the projection screen according to the present embodiment may be preferably 1% or more, more preferably 4% or more, particularly preferably 7% or more, and further preferably 10% or more. This allows the unwanted image suppression effect to be readily obtained, and the high luminance can be achieved. From another aspect, the haze value may be preferably 80% or less, more preferably 60% or less, particularly preferably 40% or less, further preferably 30% or less, and most preferably 20% or less. This can provides excellent background visibility when the projector is turned off. The specific method of measuring the haze value at the front face 0° is as described in the testing example, which will be described later.

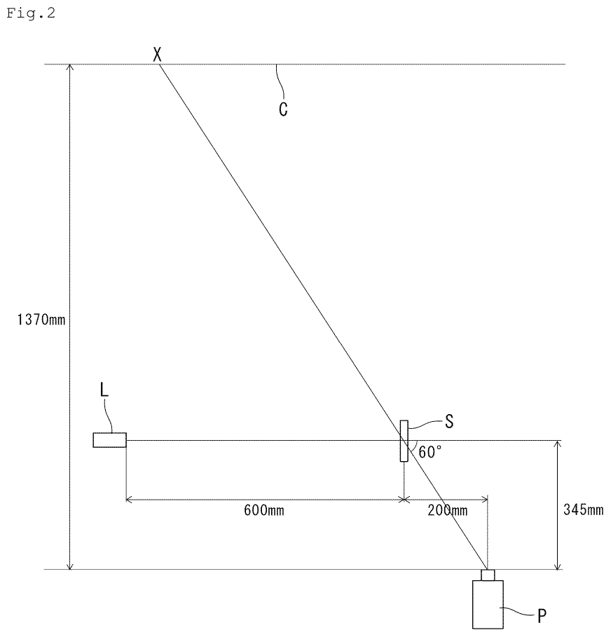

The transmission gain at the front face 0° of the projection screen according to the present embodiment when the projection screen is installed vertically to the ground surface and light is incident on the projection screen at an angle of 60° in the up-down direction from the horizontal plane (see FIG. 2) may be preferably 0.05 or more, more preferably 0.12 or more, particularly preferably 0.2 or more, and further preferably 0.3 or more. A high transmission gain leads to high luminance (brightness), so even when the surroundings are relatively bright, for example, images can be projected clearly with high luminance. This allows the display function of the projection screen to be sufficiently exerted, and the image visibility when the projector is turned on can be more excellent. The specific method of measuring the transmission gain at the front face 0° is as described in the testing example, which will be described later.

The lower limit of the incident light diffusion angle range (angle width) of the light diffusion control film in the present embodiment may be preferably 5° or more, particularly preferably 10° or more, and further preferably 15° or more. On the other hand, the upper limit of the incident light diffusion angle region (angle width) may be preferably close to 90° and may also be less than 90°. Provided that the incident light diffusion angle region of the light diffusion control film is within the above range, when the projection screen according to the present embodiment is installed vertically to the ground surface, the incident light diffusion angle region in the up-down direction can be prevented from including the front face 0° in the horizontal direction with respect to the ground surface. The incident angle for a projector is usually about −85° to 85°, but by having this incident angle for the projector in the above incident light diffusion angle region, it is possible to more effectively prevent the unwanted image formation due to the straight transmitted light from the projector. That is, the above-described unwanted image suppression effect can be more readily obtained. The method of measuring the incident light diffusion angle region in the present specification is as described in the testing example, which will be described later.

The total luminous transmittance at the front face 0° of the projection screen according to the present embodiment may be preferably 50% or more, more preferably 60% or more, particularly preferably 70% or more, and further preferably 80% or more. This can provide excellent background visibility when the projector is turned off. From another aspect, the above total luminous transmittance may be preferably 100% or less, more preferably 98% or less, particularly preferably 95% or less, and further preferably 90% or less. This allows the previously described haze value at the front face 0° to be readily satisfied. The specific method of measuring the total luminous transmittance at the front face 0° is as described in the testing example, which will be described later.

To exhibit the previously described physical properties, the projection screen according to the present embodiment may preferably have a louver-shaped internal structure (louver structure) in which the light diffusion control film includes a plurality of regions having a relatively high refractive index in a region having a relatively low refractive index. Preferably, the above louver structure may be provided so that when the projection screen is installed vertically to the ground surface, the longitudinal direction of the above louver structure extends horizontally. Also preferably, the above light diffusion control film may have the above louver structure and contain light diffusion fine particles. The previously described incident light diffusion angle region can be adjusted by the above louver structure, and the previously described haze value can be achieved by containing the above light diffusion fine particles. With such a configuration, even when the light diffusion control film is a single layer, it can sufficiently exhibit the previously described physical properties.

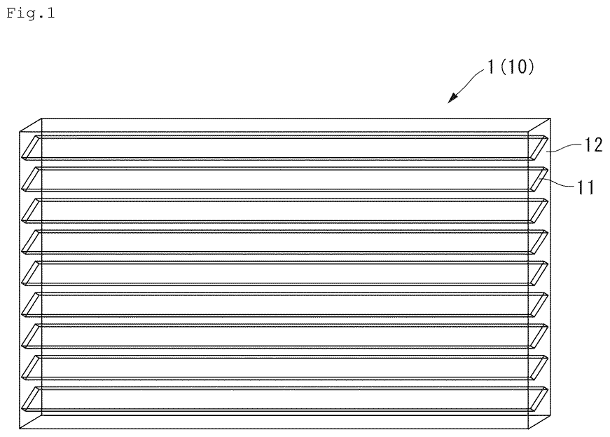

FIG. 1 illustrates a schematic perspective view of the projection screen according to an embodiment of the present invention. In FIG. 1, projection screen 1 is composed only of a light diffusion control film 10, but the present invention is not limited to this.

### 1. Structure of Light Diffusion Control Film

The light diffusion control film 10 as the projection screen 1 according to the present embodiment has a structure as the louver structure in which a plurality of plate-like high refractive index regions 11 having a relatively high refractive index are arranged in parallel at predetermined intervals and the spaces between the plate-like high refractive index regions 11 are filled with a low refractive index region 12 having a relatively low refractive index. In the present embodiment, the louver structure is formed such that when the projection screen 1 is installed vertically to the ground surface, the longitudinal direction of the above plate-like high refractive index regions 11 extends horizontally. Although not illustrated, the plate-like high refractive index regions 11 and the low refractive index region 12 may preferably contain light-diffusing fine particles.

The light incident on the light diffusion control film 1 having the louver structure as above is likely to be diffused to spread in a direction (short-side direction) perpendicular to the longitudinal direction of the plate-like high refractive index regions 11, and the incident light diffusion angle region is thereby determined. The plate-like high refractive index regions 11 in the present embodiment are arranged to be tilted with respect to the plane of the light diffusion control film 10, and this angle is appropriately adjusted so as to satisfy the previously described physical properties. In the present embodiment, an angle on the acute angle side formed between the main surface of each plate-like high refractive region 11 and the normal line of the light diffusion control film 10 may be preferably 5° to 42°, more preferably 10° to 41.5°, particularly preferably 15° to 41°, and further preferably 30° to 40°. When the plate-like high refractive index regions 11 have a shape in which the plate-like high refractive index regions 11 are bent at the middle in the thickness direction of the light diffusion control film 10 and there are a plurality of main surfaces, the above angle shall be an averaged angle of the angles of the main surfaces.

In the above louver structure, the thickness (width in the arrangement direction) of each plate-like high refractive index region 11 may be preferably 0.1 to 10 μm, particularly preferably 0.5 to 8 μm, and further preferably 1 to 5 μm. The interval between adjacent plate-like high refractive index regions 11 may be preferably 0.1 to 10 μm, particularly preferably 0.5 to 8 μm, and further preferably 1 to 5 μm.

FIG. 1 depicts the plate-like high refractive index regions 11 as existing in the entire thickness direction of the light diffusion control film 10, but the plate-like high refractive index regions 11 may not exist at least in one of end portions of the light diffusion control film 10 in the thickness direction. Here, the ratio of the plate-like high refractive index regions 11 extending in the thickness direction of the light diffusion control film 10 may be preferably 10% or more, more preferably 30% or more, and particularly preferably 50% or more from the viewpoint of making the light diffusivity more efficient. The upper limit of the ratio is not limited and may be 100%, that is, the internal structure may be formed in the entire thickness direction of the light diffusion control film 10.

In the above louver structure, the difference between the refractive index of the plate-like high refractive regions 11 having a relatively high refractive index and the refractive index of the low refractive index region 12 having a relatively low refractive index may be preferably 0.01 to 0.3, particularly preferably 0.05 to 0.25, and further preferably 0.1 to 0.2.

In the louver structure in the present embodiment, the plate-like high refractive index regions 11 have a planar shape, but may have a shape in which the plate-like high refractive index regions 11 are bent at the middle in the thickness direction of the light diffusion control film 10. Additionally or alternatively, the louver structure in the present embodiment may be a structure in which the plate-like high refractive index regions 11 are each provided as two or more portions in the thickness direction of the light diffusion control film 10 so as to have different tilt angles, different bending angles, or difference in the presence or absence of bending.

The dimensions, angles, and other parameters relating to the internal structure of the louver structure described above can be measured by observing the cross section of the louver structure using an optical digital microscope.

The thickness of the light diffusion control film 10 in the present embodiment may be preferably 20 to 700 μm, particularly preferably 40 to 500 μm, further preferably 60 to 400 μm, and also preferably 90 to 200 μm. When the thickness of the light diffusion control film 10 falls within the above range, the previously described physical properties can be readily exhibited.

### 2. Materials

The light diffusion control film 10 in the present embodiment may be preferably obtained from a composition that contains a high refractive index component, a low refractive index component having a refractive index lower than that of the high refractive index component, and light-diffusing fine particles (this composition will be referred to as a “light diffusion control composition C,” hereinafter). In particular, the light diffusion control film 10 according to the present embodiment may be preferably obtained by curing the above light diffusion control composition C, and in this case, each of the high refractive index component and the low refractive index component may preferably have one or two polymerizable functional groups. The use of such a light diffusion control composition C allows the previously described louver structure to be readily and satisfactorily formed.

The following description will be made for a case in which the light diffusion control composition C contains a high refractive index component, a low refractive index component having a refractive index lower than that of the high refractive index component, and light-diffusing fine particles and each of the high refractive index component and the low refractive index component has one or two polymerizable functional groups, but the present invention is not limited to this.

### (1) High Refractive Index Component

Preferred examples of the above high refractive index component include (meth)acrylic ester that contains an aromatic ring, and (meth)acrylic ester that contains a plurality of aromatic rings may be particularly preferred. Examples of the (meth)acrylic ester that contains a plurality of aromatic rings include those in which a part thereof is substituted with halogen, alkyl, alkoxy, alkyl halide, or the like, such as biphenyl (meth)acrylate, naphthyl (meth)acrylate, anthracyl (meth)acrylate, benzylphenyl (meth)acrylate, biphenyloxyalkyl (meth)acrylate, naphthyloxyalkyl (meth)acrylate, anthracyloxyalkyl (meth)acrylate, and benzylphenyloxyalkyl (meth)acrylate. Among these, biphenyl (meth)acrylate may be preferred from the viewpoint of readily forming a satisfactory regular internal structure. Specifically, o-phenylphenoxyethyl acrylate, o-phenylphenoxyethoxyethyl acrylate, and the like may be preferred. In the present specification, (meth)acrylic acid means both the acrylic acid and the methacrylic acid. The same applies to other similar terms.

The molecular weight (weight-average molecular weight) of the high refractive index component may be preferably 150 to 2,500, particularly preferably 200 to 2,000, and further preferably 250 to 1,000. When the molecular weight (weight-average molecular weight) of the high refractive index component falls within the above range, the light diffusion control film 10 having a desired louver structure can be readily formed. When the theoretical molecular weight of the above high refractive index component can be specified based on the molecular structure, the molecular weight (weight-average molecular weight) of the high refractive index component refers to the theoretical molecular weight (molecular weight that may not be the weight-average molecular weight). On the other hand, when it is difficult to specify the above-described theoretical molecular weight, for example, due to the above high refractive index component being a polymer component, the molecular weight (weight-average molecular weight) of the high refractive index component refers to a weight-average molecular weight obtained as a standard polystyrene-equivalent value that is measured using a gel permeation chromatography (GPC) method. As used in the present specification, the weight-average molecular weight refers to a value that is measured as the standard polystyrene equivalent value using the GPC method.

The refractive index of the high refractive index component may be preferably 1.45 to 1.70, more preferably 1.50 to 1.68, particularly preferably 1.54 to 1.65, and further preferably 1.54 to 1.59. When the refractive index of the high refractive index component falls within the above range, the light diffusion control film 10 having a desired regular internal structure and desired light diffusion control ability can be readily formed. As used in the present specification, the refractive index means the refractive index of a certain component before curing the light diffusion control composition C, and the refractive index is measured in accordance with JIS K0062: 1992.

The content of the high refractive index component in the light diffusion control composition C may be preferably to 400 mass parts, particularly preferably 40 to 300 mass parts, and further preferably 50 to 200 mass parts with respect to 100 mass parts of the low refractive index component. When the content of the high refractive index component falls within such ranges, the regions derived from the high refractive index component and the region derived from the low refractive index component exist with a desired ratio in the louver structure of the light diffusion control film 10 formed. As a result, the light diffusion control film 10 having a desired louver structure can be readily formed.

### (2) Low Refractive Index Component

Preferred examples of the above low refractive index component include urethane (meth)acrylate, a (meth)acrylic-based polymer having a (meth)acryloyl group in a side chain, a (meth)acryloyl group-containing silicone resin, and an unsaturated polyester resin, but it may be particularly preferred to use urethane (meth)acrylate.

The above urethane (meth)acrylate may be preferably formed of (a) a compound that contains at least two isocyanate groups, (b) polyalkylene glycol, and (c) hydroxyalkyl (meth)acrylate.

Preferred examples of the above (a) compound that contains at least two isocyanate groups include aromatic polyisocyanates such as 2,4-tolylene diisocyanate, 2,6-tolylene diisocyanate, 1,3-xylylene diisocyanate, and 1,4-xylylene diisocyanate, aliphatic polyisocyanates such as hexamethylene diisocyanate, alicyclic polyisocyanates such as isophorone diisocyanate (IPDI) and hydrogenated diphenylmethane diisocyanate, biuret bodies and isocyanurate bodies thereof, and adduct bodies (e.g., a xylylene diisocyanate-based trifunctional adduct body) that are reaction products with low molecular active hydrogen-containing compounds such as ethylene glycol, propylene glycol, neopentyl glycol, trimethylol propane, and castor oil. Among these, an alicyclic polyisocyanate may be preferred, and an alicyclic diisocyanate that contains only two isocyanate groups may be particularly preferred.

Preferred examples of the above (b) polyalkylene glycol include polyethylene glycol, polypropylene glycol, polybutylene glycol, and polyhexylene glycol, among which polypropylene glycol may be preferred.

The weight-average molecular weight of the above (b) polyalkylene glycol may be preferably 2,300 to 19,500, particularly preferably 3,000 to 14,300, and further preferably 4,000 to 12,300.

Preferred examples of the above (c) hydroxyalkyl (meth)acrylate include 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, and 4-hydroxybutyl (meth)acrylate.

Synthesis of the urethane (meth)acrylate using the above-described components (a) to (c) as the materials can be performed in a commonly-used method. In such a method, from the viewpoint of efficiently synthesizing the urethane (meth)acrylate, the compounding ratio of the components (a), (b), and (c) as the molar ratio may be preferably set to a ratio of 1-5:1:1-5 and particularly preferably set to a ratio of 1-3:1:1-3.

The weight-average molecular weight of the low refractive index component may be preferably 3,000 to 20,000, particularly preferably 5,000 to 15,000, and further preferably 7,000 to 13,000. When the weight-average molecular weight of the low refractive index component falls within the above range, the light diffusion control film 10 having a desired louver structure and desired light diffusion control ability can be readily formed.

The refractive index of the low refractive index component may be preferably 1.30 to 1.59, more preferably 1.35 to 1.50, particularly preferably 1.40 to 1.49, and further preferably 1.46 to 1.48. When the refractive index of the low refractive index component falls within the above range, the light diffusion control film 10 having a desired louver structure and desired light diffusion control ability can be readily formed.

### (3) Light-Diffusing Fine Particles

It may be sufficient that the light-diffusing fine particles allow the previously described physical properties to be satisfied, and examples thereof include inorganic fine particles, organic fine particles, silicone-based fine particles composed of a silicon-containing compound with an intermediate structure between inorganic and organic structures, such as silicone resin, (e.g., TOSPEARL series available from Momentive Performance Materials Japan), and hybrid fine particles of organic resins and silicone resins. One type of the light-diffusing fine particles may be used alone or two or more types may also be used in combination.

Examples of inorganic fine particles include metal oxides such as silica, aluminum oxide, zirconium oxide, titanium oxide, zinc oxide, germanium oxide, indium oxide, tin oxide, indium tin oxide (ITO), antimony oxide, and cerium oxide; and fine particles composed of metal fluorides and the like such as magnesium fluoride and sodium fluoride. Among the above, metal oxides may be preferred, titanium oxide or zinc oxide may be particularly preferred, and titanium oxide may be further preferred. The surfaces of the inorganic fine particles may be chemically modified with an organic compound or the like.

The shape of the inorganic fine particles may be any of a true spherical shape, an indefinite shape, etc., but from the viewpoint of efficiently exhibiting the light-diffusing properties with a small amount, the indefinite shape may be preferred.

The inorganic fine particles in the present embodiment may be preferably so-called nanoparticles. Specifically, the average particle diameter of the inorganic fine particles may be preferably 10 to 1,000 nm, more preferably 50 to 700 nm, particularly preferably 100 to 500 nm, and further preferably 200 to 300 nm. When the average particle diameter of the inorganic fine particles is within the above range, the previously described optical properties may be more readily satisfied. The average particle diameter of the inorganic fine particles is measured by a laser diffraction/scattering method.

The refractive index of the inorganic fine particles in embodiment may be preferably 1.8 to 3, the present particularly preferably 2 to 2.8, and further preferably 2.5 to 2.7. When the refractive index of the inorganic fine particles is within the above range, the previously described optical properties may be more readily satisfied. The refractive index of the light-diffusing fine particles in the present specification may be measured by a method in the testing example, which will be described later.

Examples of organic fine particles include those of acrylic resin, polystyrene resin, polyethylene resin, epoxy resin, and their copolymers or mixtures.

The shape of organic fine particles, silicone-based fine particles, and hybrid fine particles may be preferably spherical fine particles with uniform light diffusion. The average particle diameter of these fine particles measured by the centrifugal sedimentation light transmission method may be preferably 0.1 to 20 μm, more preferably 1 to 10 μm, and particularly preferably 3 to 6 μm. When the average particle diameter of the above fine particles is within the above range, the previously described optical properties may be more readily satisfied.

The average particle diameter measured by the above centrifugal sedimentation light transmission method may be measured using a centrifugal automatic particle size distribution analyzer (available from Horiba, Ltd., CAPA-700) for a sample for measurement prepared by sufficiently mixing 1.2 g of fine particles and 98.8 g of isopropyl alcohol.

The refractive index of the organic fine particles, silicone-based fine particles, and hybrid fine particles in the present embodiment may be preferably 1.3 to 1.8, more preferably 1.4 to 1.7, and further preferably 1.42 to 1.6. When the refractive index is within the above range, the previously described optical properties may be more readily satisfied.

When inorganic fine particles are used as the light-diffusing fine particles, the content of the light-diffusing fine particles in the light diffusion control composition C may be preferably 0.001 to 10 mass parts, more preferably 0.002 to 5 mass parts, and particularly preferably 0.005 to 1 mass part with respect to 100 mass parts of the total amount of the high refractive index component and low refractive index component. When the content of the light-diffusing fine particles is within the above range, the previously described physical properties may be readily satisfied, and the louver structure can be well formed. From the viewpoint of setting the previously described haze value to a suitable value, the content may be preferably 0.008 to 0.4 mass parts, more preferably 0.009 to 0.04 mass parts, and particularly preferably 0.01 to 0.02 mass parts. From the viewpoint of achieving both the previously described haze value and transmission gain, the content may be preferably 0.008 to 0.6 mass parts, more preferably 0.01 to 0.3 mass parts, and particularly preferably 0.02 to 0.1 mass parts.

When organic fine particles, silicone-based fine particles, or hybrid fine particles are used as the light-diffusing fine particles, the content of the light-diffusing fine particles in the light diffusion control composition C may be preferably 0.001 to 10 mass parts, more preferably 0.005 to 5 mass parts, particularly preferably 0.01 to 1 part, and further preferably 0.02 to 0.5 mass parts mass with respect to 100 mass parts of the total amount of the high refractive index component and low refractive index component. When the content of the light-diffusing fine particles is within the above range, the previously described physical properties may be readily satisfied, and the louver structure can be well formed. When silicone-based fine particles are used as the light-diffusing fine particles, the above content may be preferably 0.03 to 0.05 mass parts from the viewpoint of setting the previously described haze value to a suitable value.

### (4) Other Components

The previously described light diffusion control composition C may contain other additives in addition to the high refractive index component, low refractive index component, and light-diffusing fine particles. Examples of the other additives include a polyfunctional monomer (compound having three or more polymerizable functional groups), a photopolymerization initiator, an ultraviolet absorber, a light stabilizer, an antioxidant, an antistatic, a polymerization accelerator, a polymerization inhibitor, an infrared absorber, a plasticizer, a diluting solvent, and a leveling agent.

The light diffusion control composition C may preferably contain a photopolymerization initiator among the above-described additives. When the light diffusion control composition C contains a photopolymerization initiator, the light diffusion control film having a desired regular internal structure can be readily and efficiently formed.

Examples of the photopolymerization initiator include benzoin, benzoin methyl ether, benzoin ethyl ether, benzoin isopropyl ether, benzoin-n-butyl ether, benzoin isobutyl ether, acetophenone, dimethylaminoacetophenone, 2,2-dimethoxy-2-phenylacetophenone, 2,2-diethoxy-2-phenylacetophenone, 2-hydroxy-2-methyl-1-phenylpropan-1-one, 1-hydroxycyclohexyl phenyl ketone, 2-methyl-1-[4-(methylthio)phenyl]-2-morpholino-propan-1-one, 4-(2-hydroxyethoxy)phenyl-2-(hydroxy-2-propyl) ketone, benzophenone, p-phenylbenzophenone, 4,4-diethylaminobenzophenone, dichlorobenzophenone, 2-methylanthraquinone, 2-ethylanthraquinone, 2-tert-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethyl ketal, acetophenone dimethyl ketal, p-dimethylaminebenzoic ester, and oligo [2-hydroxy-2-methyl-1-[4-(1-methylvinyl)phenyl] propane]. These may each be used alone or two or more types may also be used in combination.

When the photopolymerization initiator is used, it may be preferred to set the content of the photopolymerization initiator in the light diffusion control composition C preferably to 0.2 to 20 mass parts, particularly preferably to 0.5 to 15 mass parts, and further preferably to 1 to 10 mass parts with respect to 100 mass parts of the total amount of the high refractive index component and the low refractive index component. By setting the content of the photopolymerization initiator in the light diffusion control composition C within the above range, the light diffusion control film 10 can be readily and efficiently formed.

The light diffusion control composition C may also preferably contain an ultraviolet absorber among the above-described additives. When the light diffusion control composition C contains an ultraviolet absorber, the light diffusion control film having a desired regular internal structure (e.g., bent structure) can be readily formed.

When the light diffusion control composition C contains an ultraviolet absorber, it may be preferably used in combination with a light stabilizer, which will be described later. The reason for this is as follows. When the light diffusion control film is used under certain conditions (e.g., when the light diffusion control film is used in an environment where it is irradiated with external light in a laminate including the light diffusion control film and an ultraviolet absorbing layer located on the external light incident side of the light diffusion control film), troubles may occur, such as liquefaction or yellow discoloration over time. Fortunately, however, by containing an ultraviolet absorber and a light stabilizer, an effect of suppressing the liquefaction and yellow discoloration of the light diffusion control film can be obtained. In the present specification, “external light” refers to light that is incident on an object (here, a laminate) from outside the object, and includes direct sunlight, sky light, and light reflected from ground objects as well as light from various types of lighting or devices, and also includes light that has passed through translucent materials such as glass and plastic.

Examples of the ultraviolet absorber include benzophenone-based compounds, benzotriazole-based compounds, triazine-based compounds, cyanoacrylates, and salicylic esters, and one type may be used alone or two or more types may be used in combination. Among these, the benzophenone-based compounds, benzotriazole-based compounds, or triazine-based compounds may be preferred, and the benzophenone-based compounds may be particularly preferred. These compounds have good compatibility with the previously described high refractive index component and low refractive index component and also have a low degree of coloring.

Preferred examples of the benzophenone-based compounds include 2,2-dihydroxy-4-methoxybenzophenone, 2,4-dihydroxybenzophenone, 2-hydroxy-4-methoxybenzophenone, 2-hydroxy-4-methoxybenzophenone-5-sulfonic acid hydrate, and 2-hydroxy-4-n-octyloxybenzophenone. Preferred examples of the benzotriazole-based compounds include 2-(2-hydroxy-5-t-butylphenyl)-2H-benzotriazole, octyl-3-[3-t-butyl-4-hydroxy-5-(5-chloro-2H-benzotriazole-2-yl]phenyl) propionate, 2-ethylhexyl-3-[3-t-butyl-4-hydroxy-5-(5-chloro-2H-benzotriazole-2-yl]phenyl) propionate, and benzenepropanoic acid-3-(2H-benzotriazole-2-yl)-5-(1,1-dimethylethyl)-4-hydroxy-alkyl ester. Preferred examples of the triazine-based compounds include 2,4-bis [2-hydroxy-4-butoxyphenyl]-6-(2,4-dibutoxyphenyl)-1, 3-5-triazine and 2-[4,6-di(2,4-xylyl)-1,3,5-triazine-2-yl]-5-octyloxyphenol. These may each be used alone or two or more types may also be used in combination.

When an ultraviolet absorber is used, the content of the ultraviolet absorber in the light diffusion control composition C may be preferably 0.001 to 5 mass %, more preferably 0.01 to 1 mass %, particularly preferably 0.02 to 0.5 mass %, and further preferably 0.06 to 0.1 mass %. This allows the light diffusion control film to readily satisfy the above-described physical properties while the curing of the light diffusion control composition C due to irradiation with ultraviolet rays proceeds without any problem. Moreover, the light diffusion control film having a desired regular internal structure (e.g., bent structure) can be readily formed.

The light diffusion control composition C may also preferably contain a light stabilizer among the above-described additives. This allows the obtained light diffusion control film to exhibit the effect of suppressing the liquefaction and yellow discoloration under the above-described certain conditions. In particular, when the light diffusion control composition C contain a light stabilizer, it may be preferably used in combination with the above-described ultraviolet absorber from the viewpoint of improving the effect of suppressing the liquefaction and yellow discoloration.

The light stabilizer is not particularly limited, and examples thereof include those composed of hindered amine-based compounds, those composed of benzophenone-based compounds, and those composed of benzotriazole-based compounds. These light stabilizers may be used alone, or two or more types may also be used in combination. These compounds have good compatibility with the previously described high refractive index component and low refractive index component, and also have a low degree of coloration.

From the viewpoint that the obtained light diffusion control film can exhibit the effect of suppressing the liquefaction and yellow discoloration while satisfying the above-described physical properties, it may be preferred to use a light stabilizer composed of a hindered amine-based compound, and in particular, a weakly basic hindered amine-based compound having a carbonate skeleton (this compound may be referred to as a “hindered amine-based compound CL,” hereinafter) may be preferred. The hindered amine refers to an amine that has bulky substituents on both sides of an amino group. As used in the present specification, being “weakly basic” refers to relatively weak or low basicity and is distinguished from ordinary “basicity.” Specifically, the relatively weak or low basicity refers to a base dissociation constant (pKb) that is preferably 6 or more, more preferably 8 or more, particularly preferably 10 or more, and further preferably 11 or more in water at 1 atm and 25° C.

The above hindered amine-based compound CL may be preferably a compound that includes at least one skeleton represented by the following general formula (I).

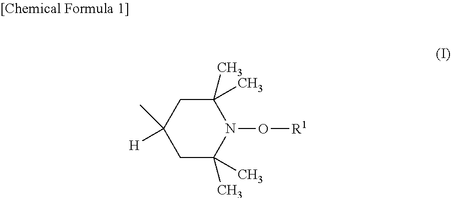

The hindered amine-based compound CL having the above structure is excellent in the effect of suppressing the liquefaction and yellow discoloration of the light diffusion control film. Moreover, the hindered amine-based compound CL in the present embodiment has an N—O—R¹ skeleton thereby to well exhibit the weak or low basicity, and the previously described effects are more excellent. It is to be noted that a hindered amine-based compound having an N-alkyl group skeleton, in particular an N—CH₃ skeleton, rather than the N—O—R¹ skeleton, exhibits basicity.

In the above hindered amine-based compound CL, R¹ in the above general formula (I) may be preferably an alkyl group. The carbon number of the alkyl group may be preferably 1 to 30, more preferably 3 to 25, particularly preferably 7 to 18, and further preferably 9 to 13. When R¹ is an alkyl group, preferred weak or low basicity is exhibited, and when the carbon number of the alkyl group is within the above range, more preferred weak or low basicity is exhibited.

The above hindered amine-based compound CL may preferably have one or more skeletons represented by the above general formula (I), more preferably have two to ten skeletons, particularly preferably have two to seven skeletons, further preferably have two to four skeletons, and most preferably have two skeletons. The one or more skeletons represented by the above general formula (I) may be present at one or more terminals of the hindered amine-based compound, at one or more side chains, or at one or more terminals and one or more side chains. When the hindered amine-based compound has two or more skeletons represented by the above general formula (I), each R¹ may be the same or may also be different.

The above hindered amine-based compound CL has a carbonate skeleton (—O—C(═O)—O—) at any position, but preferably, a terminal oxygen atom of the carbonate skeleton may be bonded to the 4-position carbon atom in the skeleton represented by the above general formula (I). By having a carbonate skeleton at this position, the hindered amine-based compound CL is more excellent in the effect of suppressing the liquefaction and yellow discoloration of the light diffusion control film.

The above hindered amine-based compound CL may be particularly preferably a compound that is represented by the following structural formula (A).

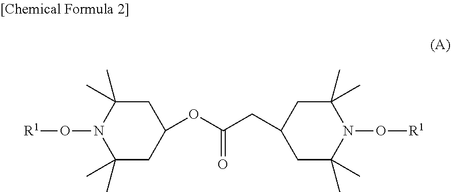

Each R¹ in the compound represented by the above structural formula (A) is the same as R¹ in the skeleton represented by the above-described general formula (I). Two R₁s in the above structural formula (A) may be the same or different, but are preferably the same.

When a light stabilizer is used, its content in the light diffusion control composition C may be preferably 0.01 to 10 mass %, more preferably 0.1 to 5 mass %, particularly preferably 0.3 to 3 mass %, and further preferably 0.5 to 2 mass %. This allows the obtained light diffusion control film to exhibit the previously described effect of suppressing the liquefaction and yellow discoloration while satisfying the above-described physical properties.

The light diffusion control composition C may also preferably contain an antioxidant among the above-described additives and may particularly preferably contain a hindered phenol-based antioxidant. This allows the light diffusion control film to be obtained with good quality and with less degradation. In particular, when the antioxidant is used in combination with the above-described light stabilizer, the obtained light diffusion control film is more likely to exhibit the effect of suppressing the liquefaction and yellow discoloration of the light diffusion control film under the above-described certain conditions.

When an antioxidant is used, its content in the light diffusion control composition C may be preferably 0.001 to 1 mass %, more preferably 0.01 to 0.5 mass %, and particularly preferably 0.02 to 0.1 mass %.

### 3. Method of Production

The method of producing the light diffusion control film according to the present embodiment is not particularly limited, and the light diffusion control film can be formed using a conventionally known method. For example, the previously described composition for light diffusion control film, preferably the light diffusion control composition C, may be prepared, and one surface of a process sheet may be coated with the composition to form a coating film. Preferably, the light diffusion control film can be formed by irradiating the above coating film with active energy rays to cure the coating film. Before or after the above irradiation with active rays, surface (in one energy particular, release surface) of a release sheet may be attached to the surface of the above coating film opposite to the process sheet, and the above coating film may be cured by irradiating the coating film with active energy rays through the process sheet or the release sheet.

The light diffusion control composition C can be prepared by uniformly mixing the previously described high refractive index component, low refractive index component and light-diffusing fine particles and, if desired, other additives such as a photopolymerization initiator.

In the above mixing, a uniform light diffusion control composition C may be obtained by stirring it while heating it to a temperature of 40° C. to 80° C. A diluting solvent may be added and mixed so that the obtained light diffusion control composition C has a desired viscosity.

Examples of the method for the above coating include a knife coating method, a roll coating method, a bar coating method, a blade coating method, a die coating method, and a gravure coating method. The light diffusion control composition C may be diluted using a solvent as necessary.

The above active energy rays refer to electromagnetic wave or charged particle radiation having an energy quantum, and specific examples of the active energy rays include ultraviolet rays and electron rays. Among the active energy rays, ultraviolet rays may be particularly preferred because of easy management.

In the curing of the coating film with active energy rays, a linear light source may be used as the light source for the active energy rays to irradiate the coating film surface with light randomly in the width direction (TD direction) and with approximately parallel strip-shaped (substantially linear) light in the flow direction (MD direction). In this operation, the tilt angle of the plate-like high refractive index regions 11 formed as the louver structure in the light diffusion control film 10 can be adjusted by adjusting the irradiation angle of the above light.

When using ultraviolet rays as the active energy rays, the irradiation condition may be preferably set such that the peak illuminance on the coating film surface is 0.1 to 50 mW/cm². Additionally or alternatively, it may be preferred to set the integrated light amount on the coating film surface to 5 to 300 mJ/cm². Additionally or alternatively, the relative moving speed of the light source for the active energy rays with respect to the above laminate may be preferably set to 0.1 to 10 m/min.

From the viewpoint of completing more reliable curing, it may also be preferred to perform irradiation with commonly-used active energy rays (active energy rays for which the process of converting the rays into strip-shaped light is not performed, scattered light) after performing the curing using the strip-shaped light as previously described. For this operation, a release sheet may be laminated on the coating film surface from the viewpoint of uniform curing.

### 4. Configuration of Projection Screen

The projection screen 1 may be composed only of the light diffusion control film 10 as described previously, may have a configuration in which a transparent base material is laminated on one surface side of the light diffusion control film 10 or transparent base materials are laminated on both surface sides, or may configured to include the light diffusion control film 10, a pressure sensitive adhesive layer laminated on one surface side of the light diffusion control film 10, and a light-transmitting member laminated on the surface of the pressure sensitive adhesive layer opposite to the light diffusion control film 10.

Examples of the transparent base material include a plastic film, a plastic plate, and a glass plate.

Examples of the above plastic film include films of polyesters such as polyethylene terephthalate, polybutylene terephthalate, and polyethylene naphthalate, polyolefin films such as polyethylene films and polypropylene films, cellophane, diacetyl cellulose films, triacetyl cellulose films, acetyl cellulose butyrate films, polyvinyl chloride films, polyvinylidene chloride films, polyvinyl alcohol films, ethylene-vinyl acetate copolymer films, polystyrene films, polycarbonate films, polymethylpentene films, polysulfone films, polyetheretherketone films, polyethersulfone films, polyether imide films, fluororesin films, polyamide films, acrylic resin films, polyurethane resin films, norbornene-based polymer films, cyclic olefin-based polymer films, cyclic conjugated diene-based polymer films, vinyl alicyclic hydrocarbon polymer films, other similar plastic films, and laminated films thereof. Among these, polyethylene terephthalate films, polycarbonate films, or the like may be preferred from the viewpoint of transparency, mechanical strength, etc.

The thickness of the above plastic film may be preferably 10 to 400 μm, more preferably 15 to 300 μm, particularly preferably 20 to 250 μm, and further preferably to 200 μm from the viewpoint of handling properties, transparency, mechanical strength, etc.

Examples of the plastic plate include, but are not limited to, acrylic plates and polycarbonate plates. The thickness of the plastic plate is not particularly limited, but usually, may be preferably 0.3 to 5 mm and more preferably 0.5 to 3 mm.

Examples of the glass plate include, but are not limited to, chemically strengthened glass, alkali-free glass, quartz glass, soda lime glass, barium/strontium-containing glass, aluminosilicate glass, lead glass, borosilicate glass, and barium borosilicate glass. The thickness of the glass plate is not particularly limited, but usually, may be preferably 0.1 to 5 mm and more preferably 0.2 to 3 mm.

The pressure sensitive adhesive layer can be formed using a known pressure sensitive adhesive. For example, an acrylic-based pressure sensitive adhesive, a silicone-based pressure sensitive adhesive, or the like can be used. The thickness of the pressure sensitive adhesive layer is not particularly limited, but usually, may be preferably 5 to 1,000 μm, particularly preferably 10 to 500 μm, and further preferably 15 to 100 μm.

Examples of the light-transmitting member include transparent hard plates such as glass plates and plastic plates and flexible transparent bodies such as plastic films. Specific examples of such light-transmitting members include, but are not limited to, glass in show windows; glass in buildings such as window glass, glass in exterior walls, and glass in partitions; glass installed in event venues; and window glass in various vehicles.

It should be appreciated that the embodiments heretofore explained are described to facilitate understanding of the present invention and are not described to limit the present invention. It is therefore intended that the elements disclosed in the above embodiments include all design changes and equivalents to fall within the technical scope of the present invention.

In the present specification, unless otherwise specified, the statement of “X to Y” (X and Y are arbitrary numbers) encompasses not only the meaning of “X or more and Y or less” but also the meaning of “preferably more than X” or “preferably less than Y.” In addition, unless otherwise specified, the statement of “X or more” (X is an arbitrary number) encompasses the meaning of “preferably more than X,” and the statement of “Y or less” (Y is an arbitrary number) encompasses the meaning of “preferably less than Y.” [Examples]

Hereinafter, the present invention will be described further specifically with reference to examples, etc., but the scope of the present invention is not limited to these examples, etc.

### Example 1

### 1. Preparation of Light Diffusion Control Composition

Polyether urethane methacrylate having a weight-average molecular weight of 9, 900 was obtained reacting polypropylene glycol, isophorone diisocyanate, and 2-hydroxyethyl methacrylate. A light diffusion control composition was obtained through compounding 60 mass parts of o-phenylphenoxyethoxyethyl acrylate, 40 mass parts of the above polyether urethane methacrylate, 8 mass parts of 2-hydroxy-2-methyl-1-phenylpropan-1-one as the photopolymerization initiator, 0.01 mass parts of titanium oxide fine particles as the light-diffusing fine particles (D1; available from Sakai Chemical Industry Co., Ltd., product name “R-62N,” average particle diameter: 0.26 μm, refractive index: 2.7), 0.08 mass parts of a benzophenone-based compound as the ultraviolet absorber (available from BASF, product name “Tinuvin 384-2”), 1.0 mass parts of a weakly basic hindered amine-based compound as the light stabilizer (hindered amine-based compound CL, base dissociation constant pKb: 11.3) represented by the following structural formula (B) and having a carbonate skeleton, and 0.05 mass parts of a hindered phenol-based antioxidant as the antioxidant (available from ADEKA CORPORATION, product name “ADEKASTAB AO-50) and then heating and mixing them under a condition of 80° C.

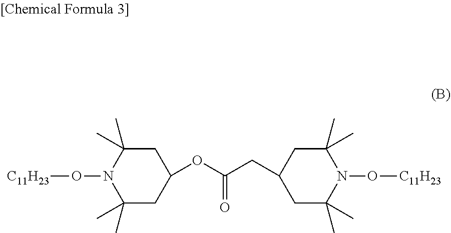

Here, the previously described weight-average molecular weight (Mw) refers to a weight-average molecular weight that is measured as a standard polystyrene equivalent value under the following conditions using gel permeation chromatography (GPC) (GPC measurement).

### ==Measurement Conditions==

Measurement apparatus: HLC-8320 available from Tosoh Corporation
GPC columns (passing through in the following order): available from Tosoh Corporation
   TSK gel super H-H
   TSK gel super HM-H
   TSK gel super H2000
Solvent for measurement: tetrahydrofuran
Measurement temperature: 40° C.

### 2. Formation of Light Diffusion Control Film

One surface of a long polyethylene terephthalate film (thickness of 188 μm; first PET film; also having a role as a process sheet) was coated with the obtained light diffusion control composition to form a coating film having a thickness of about 200 μm. A laminate composed of the coating film and the first PET film was thus obtained.

Subsequently, the obtained laminate was placed on a conveyor. At that time, the surface of the laminate on the coating film side was on the upper side, and the longitudinal direction of the first PET film was made parallel to the flow direction of the conveyor. Then, an ultraviolet irradiation apparatus (available from EYE GRAPHICS CO., LTD., product name “ECS-4011GX”) having a linear high-pressure mercury lamp with a cold mirror for light concentration was installed on the conveyor on which the laminate was placed. This apparatus can irradiate an object with ultraviolet rays concentrated in a strip shape (approximately linear shape). Upon installation of the above ultraviolet irradiation apparatus, it was installed so that the longitudinal direction of the above high-pressure mercury lamp and the flow direction of the conveyor were orthogonal to each other.

When viewed from the longitudinal direction of the high-pressure mercury lamp, the irradiation angle of the ultraviolet rays emitted from the high-pressure mercury lamp to the laminate was set to 33° with reference to the normal line to the surface of the laminate. The irradiation angle referred to herein is described as a positive value of the acute angle formed between the normal line to the surface of the laminate and the ultraviolet rays when the ultraviolet rays are emitted toward the downstream side of the flow of the conveyor with reference to the position of the laminate just below the high-pressure mercury lamp while described as a negative value of the acute angle formed between the normal line to the surface of the laminate and the ultraviolet rays when the ultraviolet rays are emitted toward the upstream side of the flow of the conveyor.

After that, while the conveyor was operated to move the above laminate at a speed of 1.0 m/min, the coating film in the laminate was cured by being irradiated with ultraviolet rays under the conditions of a peak illuminance of 2.5 mW/cm² and an integrated light amount of 40.0 mJ/cm² on the coating film surface (this curing may be referred to as “primary curing” for convenience).

Subsequently, a polyethylene terephthalate film (second PET film) having a thickness of 50 μm was laminated on the surface of the laminate on the coating film side, and the coating film was then irradiated with ultraviolet rays (scattered light) through the film under conditions of a peak illuminance of 190 mW/cm² and an integrated light amount of 180 mJ/cm², thereby curing the coating film in the laminate (this curing may be referred to as “secondary curing” for convenience). The above-described peak illuminance and integrated light amount were measured using a UV METER (available from EYE GRAPHICS CO., LTD., product name “EYE Ultraviolet Integrated Illuminance Meter UVPF-A1”) equipped with a light receiver and installed for the position of the above coating film.

Through the above primary curing and secondary curing, the above-described coating film was sufficiently cured to form a light diffusion control film. Thus, a projection screen was obtained in which the second PET film having a thickness of 50 μm, the light diffusion control film having a thickness of 200 μm, and the first PET film having a thickness of 188 μm were laminated in this order. The thickness of the light diffusion control film was measured using a constant-pressure thickness meter (available from Takara Seisakusho, product name “Teclock PG-02J”).

When microscopic observation and the like of the cross section of the formed light diffusion control film were performed, it was confirmed that a louver structure was formed inside the light diffusion control film such that a plurality of plate-like high refractive index regions were arranged in parallel at predetermined intervals. This louver structure was configured to be bent at the middle in the thickness direction of the light diffusion control film.

### Examples 2, 3, and 5 to 8 and Comparative Example 1

Projection screens were produced in the same manner as in Example 1 except that the types and compounding amounts of the light-diffusing fine particles were as listed in Table 1 in the preparation of the light diffusion control composition.

### Example 4

One surface of a long polyethylene terephthalate film (thickness of 188 μm; first PET film; also having a role as a process sheet) was coated with the light diffusion control composition, obtained in the same manner as in Example 1, to form a coating film having a thickness of about 80 μm. In addition, a polyethylene terephthalate film (second PET film) having a thickness of 50 μm was laminated on the coating film. A laminate composed of the second PET film/coating film/first PET film was thus obtained.

Primary curing of the coating film was performed by irradiating the laminate with ultraviolet rays in the same manner as in Example 1 except that the irradiation angle of the ultraviolet rays was set to 50°, and secondary curing of the coating film was then performed by irradiating the laminate with ultraviolet rays in the same manner as in Example 1. Thus, a projection screen was obtained in which the second PET film having a thickness of 50 μm, the light diffusion control film having a thickness of 80 μm, and the first PET film having a thickness of 188 μm were laminated in this order.

When microscopic observation and the like of the cross section of the formed light diffusion control film were performed, it was confirmed that a louver structure was formed inside the light diffusion control film such that a plurality of plate-like high refractive index regions were arranged in parallel at predetermined intervals. This louver structure was configured to be bent at the middle in the thickness direction of the light diffusion control film.

### Example 9

A projection screens was produced in the same manner as in Example 1 except that the light stabilizer and the antioxidant were not compounded in the preparation of the light diffusion control composition.

When microscopic observation and the like of the cross section of the formed light diffusion control film were performed, it was confirmed that a louver structure was formed inside the light diffusion control film such that a plurality of plate-like high refractive index regions were arranged in parallel at predetermined intervals. This louver structure was configured to be bent at the middle in the thickness direction of the light diffusion control film.

### Comparative Example 2

One surface of a long polyethylene terephthalate film (thickness of 188 μm; first PET film; also having a role as a process sheet) was coated with the light diffusion control composition, obtained in the same manner as in Example 1, to form a coating film having a thickness of about 30 μm. In addition, a polyethylene terephthalate film (second PET film) having a thickness of 50 μm was laminated on the coating film. A laminate composed of the second PET film/coating film/first PET film was thus obtained.

For this laminate, the coating film was irradiated with ultraviolet rays (scattered light) through the second PET film under conditions of a peak illuminance of 190 mW/cm² and an integrated light amount of 180 mJ/cm², thereby curing the coating film in the laminate. Thus, a projection screen was obtained in which the second PET film having a thickness of 50 μm, the light diffusion control film having a thickness of 30 μm, and the first PET film having a thickness of 188 μm were laminated in this order.

When microscopic observation and the like of the cross section of the formed light diffusion control film were performed, no louver structure was formed inside the light diffusion control film.

### Comparative Example 3

One surface of a long polyethylene terephthalate film (thickness of 188 μm; first PET film; also having a role as a process sheet) was coated with the light diffusion control composition, obtained in the same manner as in Example 1, to form a coating film having a thickness of about 200 μm. In addition, a polyethylene terephthalate film (second PET film) having a thickness of 50 μm was laminated on the coating film. A laminate composed of the second PET film/coating film/first PET film was thus obtained.

For this laminate, the coating film was irradiated with ultraviolet rays (scattered light) through the second PET film under conditions of a peak illuminance of 190 mW/cm² and an integrated light amount of 180 mJ/cm², thereby curing the coating film in the laminate. Thus, a projection screen was obtained in which the second PET film having a thickness of 50 μm, the light diffusion control film having a thickness of 200 μm, and the first PET film having a thickness of 188 μm were laminated in this order.

When microscopic observation and the like of the cross section of the formed light diffusion control film were performed, no louver structure was formed inside the light diffusion control film.

The details of the simplified names listed in Table 1 are as follows.

### <Light-Diffusing Fine Particles>

D1: titanium oxide fine particles (available from Sakai Chemical Industry Co., Ltd., product name “R-62N,” indefinite shape, average particle diameter: 260 nm refractive index: 2.7)

D2: light-diffusing fine particles composed of silicone resin (silicon-containing compound with an intermediate structure between inorganic and organic structures) (available from Momentive Performance Materials Japan, product name “TOSPEARL 145,” average particle diameter: 4.5 μm, refractive index: 1.43)

D3: true spherical polymethylmethacrylate-polystyrene copolymer fine particles (available from Sekisui Kasei Co., Ltd., product name “XX-11LA,” average particle diameter: 3.5 μm, refractive index: 1.56)

### <Testing Example 1> (Measurement of Refractive Index)

The refractive index of the light-diffusing fine particles used in the examples and comparative examples was measured by the following method. A sample was prepared through placing fine particles on a slide glass, dropping a refractive index standard solution onto the fine particles, and covering the fine particles with a cover glass. The sample was observed with a microscope, and the refractive index of the refractive index standard solution at which the outline of the fine particles became most difficult to see was determined as the refractive index of the fine particles.

### <Testing Example 2> (Measurement of Incident Light Diffusion Angle Region)

For the projection screen produced in each of the examples and comparative examples, an incident light diffusion angle region in which the haze value would be 60% or more was measured using a variable haze meter (available from Toyo Seiki Seisaku-sho, Ltd., product name “Haze-Gard-Plus, Variable Haze Meter”).

Specifically, the projection screen was installed so that the distance from the integrating sphere aperture in the above variable haze meter to the arrival position of the measurement light would be 62 mm. Then, a change in the haze value (%) was measured by rotating the longitudinal direction of the light diffusion control film (transport direction during preparation) with the width direction of the light diffusion control film at the above arrival position as a rotation axis. That is, only the tilt angle of the light diffusion control film was changed thereby to vary the incident angle of the measurement light with respect to the light diffusion control film, and the haze value (%) was measured at each incident angle. Provided that the incident angle of the measurement light in the normal direction of the projection screen was 0° and the direction of rotation in which the traveling direction side in the longitudinal direction of the light diffusion control film (transport direction during preparation) approached the light source gave a positive angle, the measurement was performed in a range of −70° to 70°. Details of the measurement condition were as follows.
Light source: C light source
Measuring diameter: φ18 mm
Diameter of integrating sphere aperture: φ25.4 mm

Then, the angle range in which the measured haze value (%) was 60% or more was specified as the incident light diffusion angle region. The results are listed in Table 1.

### <Testing Example 3> (Measurement of Haze Value)

For the projection screen produced in each of the examples and comparative examples, the haze value (%) was measured in accordance with JIS K7136: 2000 by using a haze meter (available from NIPPON DENSHOKU INDUSTRIES CO., LTD., product name “NDH-5000”) installed at the front face 0° of the projection screen. The results are listed in Table 2.

### <Testing Example 4> (Measurement of Total Luminous Transmittance)

For the projection screen produced in each of the examples and comparative examples, the total luminous transmittance (%) was measured in accordance with JIS K7361-1:1997 by using a haze meter (available from NIPPON DENSHOKU INDUSTRIES CO., LTD., product name “NDH-5000”) installed at the front face 0° of the projection screen. The results are listed in Table 2.

### <Testing Example 5> (Evaluation of Background Visibility)

An A4 sheet of paper on which characters (A, B, and C) and figures (∘, Δ, and x) were displayed was placed at a position 100 cm away from the projection screen produced in each of the examples and comparative examples. The font size of these characters and figures was 144 points.

Then, in a state in which no image was projected from the projector, the characters/figures as a background were visually confirmed through the projection screen. The viewer confirmed the characters/figures at a position 100 cm away from the sample. Then, the background visibility was evaluated based on the following criteria. The results are listed in Table 2.
A . . . Characters/figures were clearly confirmed.
B . . . Characters/figures were well confirmed.
C . . . Characters/figures looked blurry.
D . . . Characters/figures were not recognizable.

### <Testing Example 6> (Measurement of Transmission Gain)

The projection screen produced in each of the examples and comparative examples was cut to 50 mm long×50 mm wide, and this was used as a sample.

As illustrated in FIG. 2, a projector P (available from Ricoh Co., Ltd., product name “PJ WX4152N,” single focus projector) was installed vertically facing a ceiling C so that the distance from the lens tip to the ceiling C was 1,370 mm. In addition, the above sample (sample S) was installed vertically so that the height of the center position of the above sample S was 345 mm from the lens tip of the projector P and the horizontal position of the above sample S was 200 mm from the lens center of the projector P. At that time, the angle formed by the imaginary line from the lens tip center of the projector P to the height center of the sample S and the horizontal line passing through the height center of the sample S was 60°. Furthermore, a luminance meter L (available from KONICA MINOLTA, INC., product name “LS-110”) was installed at a position on the opposite side of the projector P, at the same height as the center height of the above sample S, and at a horizontal distance of 600 mm from the sample S.

Using the above configuration, the sample S was irradiated with light from the projector P at an angle of 60°, and the luminance (cd/m²) at the front face 0° of the sample S was measured by the luminance meter L. In addition, the illuminance of the projector P was also measured using an illuminance meter (available from HIOKI E.E. CORPORATION, product name “LUX HiTESTER 3423”), and the obtained illuminance was divided by n to calculate the luminance (cd/m²) of completely diffused light. Then, the luminance at the front face 0° of the sample S was divided by the luminance (cd/m²) of completely diffused light to calculate the transmission gain at the front face 0° (0° gain). The results are listed in Table 2.

### <Testing Example 7> (Evaluation of Unwanted Image Suppression)

In the same configuration as in Testing Example 6, visual confirmation was made as to whether or not an image projected from the projector P (image by straight transmitted light) was reflected to form an image at a portion at which the extension of the imaginary line from the lens tip center of the projector P to the height center of the sample S intersected with the ceiling C (indicated by X in FIG. 2). The image used was a paused image of a television (in which rectangular figures were arranged with various colors). Then, the unwanted image suppression was evaluated based on the following criteria. The results are listed in Table 2.
∘ . . . There was no image reflection.
X There was image reflection.

### <Testing Example 8> (Evaluation of Visibility)

In the same configuration as in Testing Example 6, a paused image of a television (in which rectangular figures were arranged with various colors) was projected from the projector onto the projection screen. The image projected on the projection screen was visually confirmed from a position on the opposite side of the projector, at the height center of the projection screen, and at the front face 0°. The viewer confirmed the projected image at a position 100 cm away from the sample. Then, the visibility was evaluated based on the following criteria. The results are listed in Table 2.
A: Boundaries of the image were clearly visible.
B: Boundaries of the image were well visible.
C: Boundaries of the image looked blurry.
D: Boundaries of the image were not recognizable.

### <Testing Example 9> (Evaluation of Liquefaction Suppression)

An acrylic-based pressure sensitive adhesive layer (no ultraviolet absorber, thickness 25 μm) was laminated on the first PET film side of the projection screen produced in each of the examples and comparative examples.

Then, an acrylic-based pressure sensitive adhesive layer (thickness 20 μm) containing an ultraviolet absorber was laminated on one surface of a first polyvinyl chloride resin (PVC) film (containing an ultraviolet absorber, thickness 80 μm).

In addition, an aluminum layer (nano-order thickness) was vapor-deposited as a reflective layer on one surface of a second PVC film (no ultraviolet absorber, thickness 50 μm). Then, an acrylic-based pressure sensitive adhesive layer (no ultraviolet absorber, thickness 25 μm) was laminated on the surface of the PVC film opposite to the reflective layer. Furthermore, an acrylic-based pressure sensitive adhesive layer (thickness 20 μm) containing an ultraviolet absorber was laminated on one surface of a fluorine-based resin film (containing an ultraviolet absorber, thickness 100 μm).

The above constitutional bodies were laminated to obtain a laminate composed of the fluorine-based resin film, the acrylic-based pressure sensitive adhesive layer containing an ultraviolet absorber, the first PVC film, the acrylic-based pressure sensitive adhesive layer containing an ultraviolet absorber, the second PET film, the light diffusion control film, the first PET film, the acrylic-based pressure sensitive adhesive layer, the reflective layer, the second PVC film, and the acrylic-based pressure sensitive adhesive layer in this order from the top.

The laminate thus obtained was irradiated with ultraviolet rays from the above fluorine-based resin film side for 3,000 hours (irradiance: 78.5 W/m²) under an atmosphere of a temperature of 63±3° C. (black panel temperature) and 50% RH in accordance with JIS A1439: 2016 using a sunshine weather-ometer (SWOM) (available from Suga Test Instruments Co., Ltd., product name “S80”). Subsequently, the laminate was disassembled and the liquefaction of the light diffusion control film was examined.

Then, evaluation of the liquefaction suppression was performed based on the following evaluation criteria. As a result, Examples 1 to 8 and Comparative Examples 1 to 3 were evaluated as “∘” and Example 9 as

### ==Evaluation Criteria for Liquefaction Suppression==

∘ . . . Liquefaction did not occur at all.
Δ . . . When the light diffusion control film was peeled off from the PET film, some stickiness was observed on the surface of the light diffusion control film.
x . . . Liquefaction occurred overall.

TABLE 1

| | Light-diffusing | | | | |
|---|---|---|---|---|---|
| | fine particles | | | Light diffusion | |
| | | | Addition | control film | |
| | | Average | amount | | Incident light |
| | | diameter | (mass | Thickness | diffusion angle |
| | Type | (μm) | parts) | (μm) | region (°) |
| Example 1 | D1 | 0.26 | 0.01 | 200 | −67.13~−16.24 |
| Example 2 | D1 | 0.26 | 0.03 | 200 | −66.93~−20.10 |
| Example 3 | D1 | 0.26 | 0.05 | 200 | −65.61~−18.37 |
| Example 4 | D1 | 0.26 | 0.20 | 80 | −69.19~−35.43 |
| Example 5 | D2 | 4.5 | 0.03 | 200 | −61.57~−17.68 |
| Example 6 | D2 | 4.5 | 0.10 | 200 | −70.00~−20.60 |
| Example 7 | D3 | 3.5 | 0.03 | 200 | −60.59~−17.89 |
| Example 8 | D3 | 3.5 | 0.10 | 200 | −70.00~−21.06 |
| Example 9 | D1 | 0.3 | 0.03 | 200 | −67.43~−19.86 |
| Comparative | D1 | 0.26 | 1.00 | 200 | −70.00~70.00 |
| Example 1 | | | | | |
| Comparative | D1 | 0.26 | 0.01 | 30 | None |
| Example 2 | | | | | |
| Comparative | D1 | 0.26 | 0.01 | 200 | None |
| Example 3 | | | | | |

TABLE 2

| | Evaluation without | | | Evaluation with | | |
|---|---|---|---|---|---|---|
| | projection from projector | | | projection from projector | | |
| | | Total | Back- | | unwanted | |
| | Haze | luminous | ground | | image | |
| | value | transmittance | visi- | 0° | reflection | Visi- |
| | (%) | (%) | bility | gain | suppression | bility |
| Example 1 | 14.3 | 86.4 | A | 0.29 | ∘ | B |
| Example 2 | 24.2 | 84.4 | B | 0.38 | ∘ | A |
| Example 3 | 36.9 | 82.1 | C | 0.42 | ∘ | A |
| Example 4 | 38.5 | 82.0 | C | 0.26 | ∘ | B |
| Example 5 | 12.6 | 87.3 | A | 0.06 | ∘ | C |
| Example 6 | 23.9 | 87.2 | B | 0.11 | ∘ | C |
| Example 7 | 11.3 | 87.4 | A | 0.07 | ∘ | C |
| Example 8 | 14.7 | 87.4 | A | 0.08 | ∘ | C |
| Example 9 | 24.1 | 84.6 | B | 0.37 | ∘ | A |
| Comparative | 99.5 | 45.6 | D | 0.50 | ∘ | A |
| Example 1 | | | | | | |
| Comparative | 4.7 | 88.3 | A | 0.03 | x | D |
| Example 2 | | | | | | |
| Comparative | 9.0 | 86.5 | A | 0.06 | x | C |
| Example 3 | | | | | | |

As found from Table 2, according to the projection screens produced in the examples, it was able to suppress the unwanted reflection of images. Moreover, the projection screens produced in the examples were excellent in the visibility when the projector was turned on, and also excellent in the background visibility when the projector was turned off.

### INDUSTRIAL APPLICABILITY

The projection n screen of the present invention is suitably used as a transmissive projection screen that is required to be free of unwanted image reflections.

### DESCRIPTION OF REFERENCE NUMERALS

1 . . . Projection screen
10 . . . Light diffusion control film
11 . . . Plate-like high refractive index regions
12 . . . Low refractive index region
S . . . Sample
P . . . Projector
C . . . Ceiling
L . . . Luminance meter

1. A projection screen comprising a light diffusion control film having an incident light diffusion angle region, wherein
when the projection screen is installed vertically to a ground surface, the incident light diffusion angle region in an up-down direction does not include a front face 0° in a horizontal direction with respect to the ground surface, and
a haze value at the front face 0° is 1% or more and 80% or less.

2. The projection screen according to claim 1, wherein when the projection screen is installed vertically to the ground surface and light is incident on the projection screen at an angle of 60° in the up-down direction from a horizontal plane, a transmission gain at the front face 0° is 0.05 or more.

3. The projection screen according to claim 1, wherein the incident light diffusion angle region of the light diffusion control film is 0° or more and less than 90°.

4. The projection screen according to claim 1, wherein its total luminous transmittance at the front face 0° is 50% or more and 100% or less.

5. The projection screen according to claim 1, wherein
the light diffusion control film has a louver-shaped internal structure comprising a plurality of regions having a relatively high refractive index in a region having a relatively low refractive index, and
the louver-shaped internal structure is provided so that a longitudinal direction of the louver-shaped internal structure extends horizontally when the projection screen is installed vertically to the ground surface.

6. The projection screen according to claim 5,
wherein the light diffusion control film contains light-diffusing fine particles.

7. The projection screen according to any one of claims 1 to 6, wherein it is a transmissive projection screen.
